(19) United States
(12) Patent Application Publication
(10) Pub. No.: US 2019/0276198 A1
(43) Pub. Date: Sep. 12, 2019

(54) DUAL OPENING DISPENSING PACKAGE

(71) Applicants: Mounib Fares Aoun, Raleigh, NC (US); James Gordon Passe, Raleigh, NC (US)

(72) Inventors: Mounib Fares Aoun, Raleigh, NC (US); James Gordon Passe, Raleigh, NC (US)

(21) Appl. No.: 15/914,649

(22) Filed: Mar. 7, 2018

(51) Int. Cl. B65D 47/12; B65D 77/20; B65D 85/72; B65D 47/36; A23L 27/60

(52) U.S. Cl. CPC B65D 47/12; B65D 77/2024; B65D 85/72; A23V 2002/00; A23L 27/60; A23L 27/63; B65D 2577/205; B65D 47/36

(57) ABSTRACT

A dual opening dispensing package wherein, in one position, the package can be squeezed to remove product but also can be opened to full access such as for dipping French fries in ketchup.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

### Field of the Invention

The present invention relates to a dual opening dispensing package. In particular, it relates to a package that can be fully opened or have a metered opening.

### Description of Related Art

The containment of products such as foodstuff, body care products, cosmetics, perishable products, and the like in small containers, especially single serve, is well known. These products are normally flowable even if thickened if in a squeezable container with a metered opening like toothpaste. They include liquids, gel, and thickened or thick products. Examples of such substances include milk, yogurt, honey, jam, peanut butter, chocolate spread, dips, mayonnaise, ketchup, mustard, liquid soap, shampoo, hair conditioner, makeup, and the like. It is known that these products are increasing in popularity, especially the single serve/one person type packages.

Frequently there is a need, as well, to be able to open the package completely to gain access to the contents all at once so a metered opening is impractical. An example is ketchup packages which can be sealed tubs which, when opened, allow for dipping of French fries. Yet, also available are ketchup packages with a tear end which are designed for squeezing the ketchup out where a user can't dip their French fries. Frequently, there is a need to reseal the package if the contents are not entirely used and there is very little in the way of solutions for single use packages. One approach to provide both full and metered access is shown in U.S. Pat. Nos. 7,703,619 and 8,403,161 where a single layer top can be torn off to provide complete opening and at one end a fracture line is created in the base which breaks and opens the end of a channel molded into the end of the package where ketchup can be dispensed out of a metered opening. Some problems exist with this approach, however. First, the manufacture of both a channel and fracture line that extends out from the base and the lid is extremely expensive and complicated to manufacture when compared to a simple package of the other available containers. Second, the package must be made of a stiff plastic to allow the fracture line to operate properly, which is difficult to squeeze to get product out of the metered opening. Third, this type of metered opening is difficult to open and once the metered opening has been fractured along the fracture line, the package cannot be resealed easily, if at all.

Being able to provide a dual opening small package for dispensing flowable material without the above and other problems is still needed.

### BRIEF SUMMARY OF THE INVENTION

The present invention relates to the discovery that a multi-piece peel off lid can be utilized which allows either full opening of the package or the opening of a metered opening. In one embodiment, either the metered or full opening, or both, can be resealed.

Accordingly, in one embodiment, there is a package for dispensing a flowable product comprising:
a) a lower shell which defines a cavity for containing the flowable product, the shell having an upper circumferential lip;
b) a shell closure comprising:
   i. a bottom layer which covers at least a portion of the cavity has a hole for metered dispensing of the product and is attached to at least a portion of the circumferential lip; and
   ii. a top layer which is positioned on top of the bottom layer and is attached such that it covers and is attached to the bottom layer and any portion of the circumferential lip not covered by the bottom layer; and
c) wherein the shell closure top layer be removed to provide a complete opening to the cavity and wherein the shell closure top layer can alternatively be at least partially removed without removing the bottom layer in a manner to expose the hole for metered dispensing.

In another embodiment, there is a package for dispensing a flowable product comprising:
a) a lower shell having sides which defines a cavity for containing the flowable product, the shell having an upper circumferential lip and a hole for metered dispensing of the product;
b) a first shell closure comprising a top layer which entirely covers the cavity by attaching to the circumferential lip;
c) a second shell closure comprising a side layer for entirely closing the hole for metered dispensing; and
d) wherein the shell closure top layer can be removed to provide a complete opening to the cavity and wherein the second shell closure can be removed to provide an opening of the metered dispensing hole.

### BRIEF DESCRIPTION OF THE DRAWINGS

FIG. 1 is an exploded view of an embodiment of the invention.

FIG. 2 is an exploded view of an alternate embodiment.

FIGS. 3a, 3b, and 3c are perspective views of different embodiments of the invention of FIG. 1 and FIG. 2.

FIG. 4 is an exploded view of an alternate embodiment.

FIG. 5 is a perspective view of the embodiment of FIG. 4.

### DETAILED DESCRIPTION OF THE INVENTION

While this invention is susceptible to embodiment in many different forms, there is shown in the drawings and will herein be described in detail, specific embodiments with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings. This detailed description defines the meaning of the terms used herein and specifically describes embodiments in order for those skilled in the art to practice the invention.

### Definitions

The terms “about” and “essentially” mean±10 percent.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

The term “comprising” is not intended to limit inventions to only claiming the present invention with such comprising language. Any invention using the term comprising could be separated into one or more claims using “consisting” or “consisting of” claim language and is so intended.

Reference throughout this document to “one embodiment”, “certain embodiments”, “an embodiment,” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B, or C” means any of the following: “A; B; C; A and B; A and C; B and C; A, B, and C”. An exception to this definition will occur only when a combination of elements, functions, steps, or acts are in some way inherently mutually exclusive.

The drawings featured in the figures are for the purpose of illustrating certain convenient embodiments of the present invention, and are not to be considered as limitation thereto. Term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein and use of the term “means” is not intended to be limiting.

As used herein, the term “package” refers to a container for holding a certain amount of a flowable product for use either all at once or in a metered fashion. It can be a large package or a single unit package such as a single use ketchup package. The package will have both a complete opening for access to the product cavity all at once and a metering hole for access the product in a metered way by squeezing the package such that product flows out of the metering hole. The package can be made of any material known in the art, either stiff or flexible, as desired.

As used herein, the term “flowable product” refers to any product normally flowable, even if thickened, if in a squeezable container with a metered opening like toothpaste. They include liquids, gel, and thickened or thick products. Examples of such substances include milk, yogurt, honey, jam, peanut butter, chocolate spread, mayonnaise, ketchup, mustard, liquid soap, shampoo, hair conditioner, makeup, and the like. It is clear that the flowable product must be chemically compatible with the shell and closure materials selected. That selection is within the skill in the art in view of the disclosure herein.

As used herein, the term “lower shell” refers to a lower portion of the package which defines a cavity for containing the flowable product. It will have a lip which is positioned at least partially or wholly circumferentially at a top portion of the shell. In one embodiment, the shell has a bottom and sides which define the circumference of the shell. The circumferential lip is positioned on the top of the sides of the shell. See for further example the figures which shows an essentially horizontal lip on the shell.

As used herein, the term “cavity” refers to a space in the shell designed to hold the given amount of flowable product. The shape of the cavity can be anything within the parameters of the construction of the package including tubular, cube like, and the like.

As used herein, the term “upper circumferential lip” refers to the top edge, in one embodiment flat, that is used to adhere a closure by the closures circumference.

As used herein, the term “shell closure” refers to a flexible material used to attach to the shell to close and provide storage of the product in the package.

As used herein, the term “top layer” refers to a generally flexible material which entirely covers the cavity or the bottom layer by attaching (e.g. by adhesive, either reusable or not) to circumference or a portion of the circumference of the lip of the shell to provide a cover of the cavity or a cover on the bottom layer. The figures go into more detail and one skilled in the art can utilize generally accepted principles to choose materials and adhesives. The top layer can have a tab for aiding in removal of the top layer in the normal manner.

As used herein, the term “bottom layer” refers to a flexible material which covers at least a portion of the circumferential lip and has a hole for metered dispensing of the flowable product. The bottom layer can be removed at the same time as the top layer or where the bottom layer only covers a portion of the bottom, it could remain fixed as long as there is access to the cavity when the top layer is removed.

As used herein, the term “hole for metered dispensing” refers to a hole in either the bottom layer or in the side of the shell of a size that when the shell is squeezed, product can flow out the hole. In general, it can be from about ⅛ inch to ½ inch in diameter, however, the size can depend on the size of the shell and the flowability of the product. The hole is shown in the figures on a particular side, but the invention contemplates the hole being anywhere desired in the bottom layer or side of the container.

As used herein, the term “resealable” refers to selection of an adhesive which allows the top layer or second shell closure to reseal the cavity or hole respectively. Such adhesives are well known in the art.

As used herein, the term “second shell closure” refers to a layer closure for covering and sealing a metering hole in the side of the shell. It can be single use or resealable.

In using the package, one can remove both the top and bottom layer for access to the cavity or where there is a single layer on top, just removing the top layer. If smaller amounts are utilized, just removing the top layer leaving the bottom layer with a hole in place can be utilized. Where a second layer is utilized, the top layer may only be partially removed to expose the hole.

### DRAWINGS

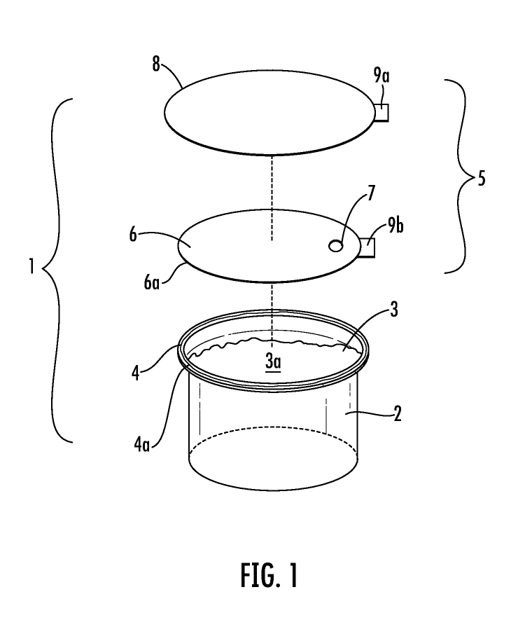

Now referring to the drawings, FIG. 1 is an exploded view of an embodiment of the present invention. The package for dispensing a flowable product 1 consists of three parts, as shown. A lower shell 2 defines cavity 3 for placement of a flowable product 3a. The shell 2 has a circumferential lip 4 which is used to adhere the shell closure 5. Also in use once the shell closure is removed, only the shell is left for complete access to the flowable product 3a, e.g. one can dip French fries into ketchup. Attachment of the shell closure 5 to the circumferential lip 4 is by means of adhesive 4a shown on the lip, but the adhesive can be on the lip or on the pieces of the shell closure as desired in order to removably attach the shell closure 5. The shell closure 5 consists of a bottom layer 6 which, in this view, attaches entirely to circumferential lip 4 via bottom layer circumferential lip 6a. The bottom layer 6 also has a dispensing hole 7 which is prevented from leaking or dispensing flowable product 3a by placement of a top layer 8 directly on top of bottom layer 6. Also shown are pull tabs 9a and 9b which are not attached to the circumferential lip 4 and can be used singly or together to pull and remove the top layer, bottom layer, or both.

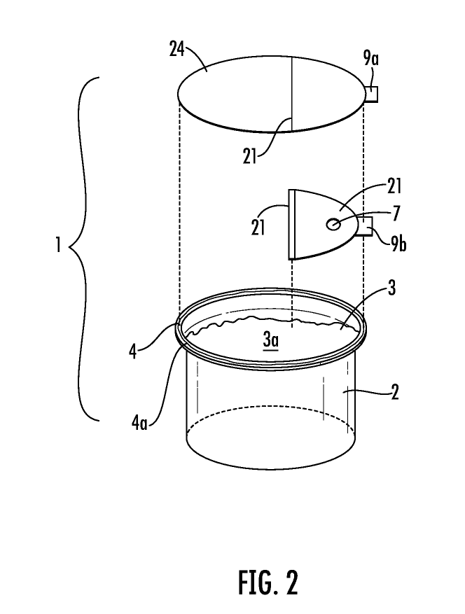

FIG. 2 is an exploded view of another embodiment of the invention. In this view, the shell 2 is the same as in FIG. 1. In this view however, the bottom layer 21 with hole 7 is smaller and only covers a portion of the circumferential lip 4. It is adhered to the circumferential lip in the same manner as above and is within the skill in the art. The difference in this case is there is a line of adhesive on a portion of the bottom layer or top layer 24 which adheres the bottom layer 21 to top layer 24 in a non-removable manner. Top layer 24 then adheres to the bottom layer and to the circumferential lip 4 of the shell 2 in order to seal the package 1.

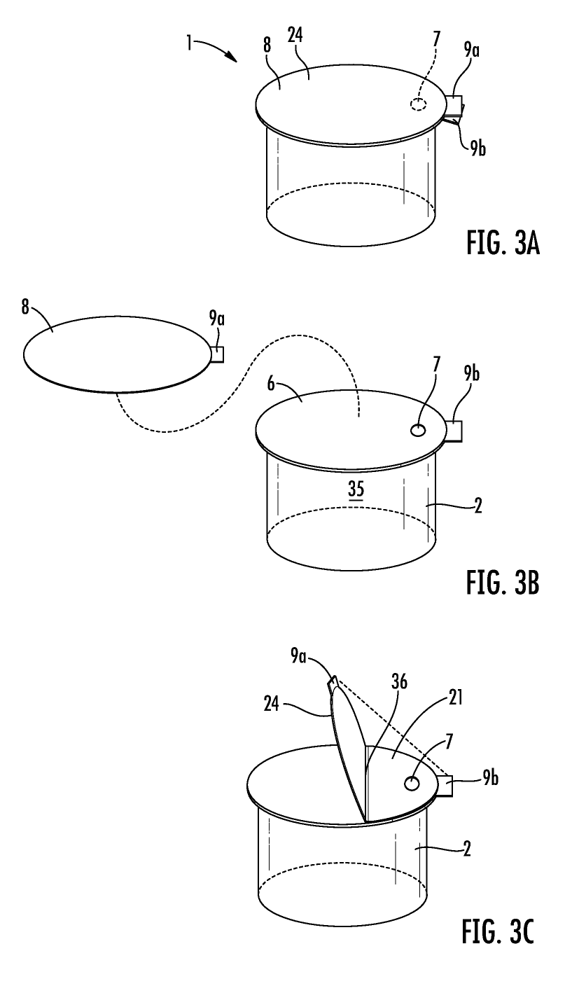

FIGS. 3a, 3b, and 3c show the sealed package and opening to the metered hole depending on if FIG. 1 or FIG. 2 construction is utilized. FIG. 3a is a perspective view of the sealed package depicting in either FIG. 1 or FIG. 2. In this view, the bottom layer 6 or 21 is not seen since it is covered either by top 8 or 24. FIG. 3b is a perspective view of the invention where the top layer 8 is taken entirely off. In FIG. 3c, the top layer 24 is peeled back halfway thus can be a limitation of the package so the lid does not get separated from the package. One skilled in the art could attach the top layer to prevent complete removal in variations of the disclosure.

In FIG. 3b is a dispensary package opened for metered dispensing using the construction of FIG. 1. In this view, flowable product is removed by squeezing the sides 35 of shell 2. The circumferential lip 4 is hidden and completely covered by the bottom layer 6. The top layer 8 was removed by grasping the tab 9a and pulling horizontally till the top is removed or at least clears the dispensing hole. It is noted, in some embodiments, the selection of adhesive is such that the top layer 8 can be replaced resealing the package for storage and later use.

In FIG. 3c where bottom layer 21 is shown, the top layer 24 is pulled back but only to the adhesive line 36. Dispensing can occur then in the same manner as in FIG. 3b. In this view as well, we note it takes less material and the top and bottom layers remain attached to the shell making cleanup easier. It is also simpler to reseal the package if the appropriate adhesive is utilized.

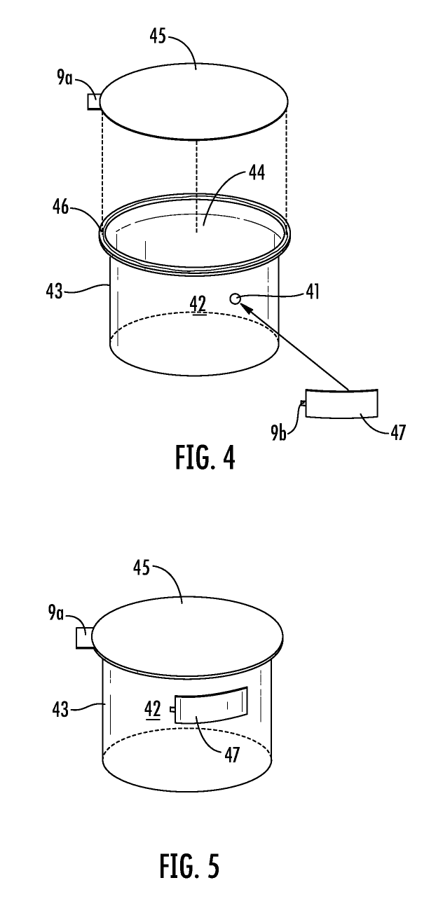

FIG. 4 is an exploded view of an alternate embodiment of the present invention. In this embodiment we can see that rather than have the metering hole in the shell closure bottom layer, the dispensing hole 41 is in the side wall 42 of shell 43 with cavity 44. In this view, a first shell closure 45 is attached to shell circumferential lip 46. This embodiment also has a tab 9a for aiding in removal of the first shell closure 45. A second closure 47 is utilized and attached to sidewall 42 and covering hole 41. By removal of either the first closure, or second closure one can access the complete opening or the metered opening respectively. FIG. 5 is a perspective view of the sealed package of FIG. 4.

Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings. Consequently, while the present invention has been described with reference to particular embodiments, modifications of structure, sequence, materials, and the like apparent to those skilled in the art still fall within the scope of the invention as claimed by the applicant.

What is claimed is:

1. A package for dispensing a flowable product comprising:
a) a lower shell which defines a cavity for containing the flowable product, the shell having an upper circumferential lip;
b) a shell closure comprising:
iii. a bottom layer which covers at least a portion of the cavity has a hole for metered dispensing of the product and is attached to at least a portion of the circumferential lip; and
iv. a top layer which is positioned on top of the bottom layer and is attached such that it covers and is attached to the bottom layer and any portion of the circumferential lip not covered by the bottom layer; and
c) wherein the shell closure can be removed to provide a complete opening to the cavity and wherein the shell closure top layer can alternatively be at least partially removed without removing the bottom layer in a manner to expose the hole in the bottom layer for metered dispensing.

2. The package according to claim 1 wherein the shell closure top and bottom layers have aligned tabs, first tabs at a first side of the circumferential lip such that pulling of the two tabs simultaneously removes both top and bottom layer.

3. The package according to claim 1 wherein there is a top layer tab on the top layer that is not attached to the bottom layer such that pulling on the top layer tab at least partially removes the top layer and exposes the hole for metered dispensing.

4. The package according to claim 1 wherein the lower shell is made of a rigid material.

5. The package according to claim 1 wherein the lower shell is made of a flexible material.

6. The package according to claim 1 wherein the top layer only is removed to provide a metered opening.

7. The package according to claim 1 wherein the top and bottom layers are removed to provide a complete opening.

8. The package according to claim 7 wherein the top and bottom layer can be removed simultaneously.

9. The package according to claim 1 wherein the cavity contains a foodstuff.

10. The package according to claim 9 wherein the foodstuff is selected from the group consisting of mayonnaise, mustard, dips, and ketchup.

11. The package according to claim 1 wherein the shell closure is resealable.

12. A package for dispensing a flowable product comprising:
a) a lower shell having sides which defines a cavity for containing the flowable product, the shell having an upper circumferential lip and a hole for metered dispensing of the product;
b) a first shell closure comprising a top layer which entirely covers the cavity by attaching to the circumferential lip;
c) a second shell closure comprising a side layer for entirely closing the hole for metered dispensing; and
d) wherein the shell closure top layer can be removed to provide a complete opening to the cavity and wherein the second shell closure can be removed to provide an opening of the metered dispensing hole.

13. The package according to claim 12 wherein the cavity contains a foodstuff.

14. The package according to claim 13 wherein the foodstuff is selected from the group consisting of mayonnaise, mustard, dips, and ketchup.

15. The package according to claim 12 wherein the shell closure is resealable.

16. The package according to claim 12 wherein the lower shell is made of a rigid material.

17. The package according to claim 12 wherein the lower shell is made of a flexible material.
